(19) United States
(12) Patent Application Publication
(10) Pub. No.: US 2009/0214872 A1
(43) Pub. Date: Aug. 27, 2009

(54) OPTICAL FILM, POLARIZING PLATE, IMAGE DISPLAY DEVICE AND METHOD FOR MANUFACTURING OPTICAL FILM

(76) Inventors: Hiroyuki Minami-Ashigara-shi, Kanagawa (JP); Kenichi Fukuda, Minami-Ashigara-shi (JP)

Correspondence Address: BIRCH STEWART KOLASCH & BIRCH, PO BOX 747, FALLS CHURCH, VA, 22040-0747, US

(21) Appl. No.: 12/393,815

(22) Filed: Feb. 26, 2009

(30) Foreign Application Priority Data
Feb. 27, 2008 (JP) P2008-046289

(51) Int. Cl. G02B 1/11; B32B 27/28; B05D 5/06

(52) U.S. Cl. 428/421; 427/163.1

(57) ABSTRACT

An optical film is provided, the optical film including: a transparent support; and at least one low refractive index layer on or above the transparent support, the low refractive index layer being obtained by hardening a composition containing: (A) a fluorine atom-free polymerizable compound having two or more ethylenically unsaturated groups in one molecule thereof; (B) low refractive index inorganic fine particles; and (C) a polyrotaxane compound.

### BACKGROUND OF THE INVENTION

1. Field of the Invention

The present invention relates to an optical film having a low refractive index layer; a method for manufacturing an optical film having a low refractive index layer; a polarizing plate using the optical film; and an image display device using the optical film or the polarizing plate on the uppermost surface of a display.

2. Description of the Related Art

In general, in display devices, for example, a cathode ray tube display device (CRT), a plasma display panel (PDP), an electroluminescence display (ELD), a liquid crystal display device (LCD), etc., for the purpose of preventing a lowering of contrast to be caused due to reflection of external light or reflection of an image, an optical film in which a low refractive index layer is provided, thereby reducing a reflectance utilizing a principle of light interference is disposed on the uppermost surface of an image display device.

Since the foregoing optical film is disposed on the uppermost surface of an image display device, the low refractive index layer serving as the uppermost layer is required to have high scratch resistance. However, in order to realize high scratch resistance in the low refractive index layer which is a thin layer, strength of the film itself and excellent adhesion to a lower layer are necessary.

In the optical film, in order to realize a low reflectance, it is necessary to lower the refractive index of the low refractive index layer. As one of measures for forming a low refractive index layer, there is known a method of coating and hardening low refractive index inorganic fine particles together with a polymerizable compound (JP-A-2004-272197). According to this method, though lowering of the refractive index is attained to some extent, when it is intended to increase the content of the low refractive index inorganic fine particles for the purpose of further lowering the refractive index, there was involved a problem that cohesion of these particles occurs, resulting in deterioration of coating surface properties and lowering of the strength of the film.

On the other hand, in coating films for non-exposed surface which are used in an undercoat layer of body painting of an automobile, etc., impartation of scratch resistance is being investigated, and a paint containing an oleophilic polyrotaxane having a hydrophobic group introduced thereinto is proposed (JP-A-2007-106863). This patent document discloses that the scratch resistance against a rubbing cloth is improved in coating films for non-exposed surface having a thickness of from about 20 to 40 μm. However, it is not suggested that this technology is applied to a low refractive index layer for optical film having a thickness of less than 1 μm.

### SUMMARY OF THE INVENTION

The problems of the invention are first to provide an optical film which is excellent in antireflection ability; second to provide an optical film which is satisfactory in coating surface properties and excellent in strength of a coating film; third to provide an optical film with quick hardening adaptability to the mass production; and fourth to provide a polarizing plate and an image display device each including such an optical film and also to provide a method for manufacturing such an optical film.

The present inventors made extensive and intensive investigations. As a result, it has been found that the foregoing problems can be solved by the following methods.

That is, the foregoing objects of the invention have been attained by the following measures.

(1) An optical film, comprising:

a transparent support; and

at least one low refractive index layer on or above the transparent support, the low refractive index layer being obtained by hardening a composition containing:
(A) a fluorine atom-free polymerizable compound having two or more ethylenically unsaturated groups in one molecule thereof;
(B) low refractive index inorganic fine particles; and
(C) a polyrotaxane compound.

(2) The optical film as described in (1) above,

wherein the fluorine atom-free polymerizable compound (A) contains an ethylene oxide-modified compound.

(3) The optical film as described in (1) or (2) above,

wherein the low refractive index inorganic fine particles (B) are inorganic fine particles containing porous or hollow silica as a major component.

(4) The optical film as described in any one of (1) to (3) above,

wherein the polyrotaxane compound (C) has an ethylenically unsaturated group.

(5) The optical film as described in any one of (1) to (4) above,

wherein the composition further contains (D) a polymerization initiator.

(6) The optical film as described in any one of (1) to (5) above, further comprising:

at least one optical functional layer between the transparent support and the low refractive index layer.

(7) A polarizing plate, comprising:

a polarizer; and

at least two protective films sandwiching the polarizer,

wherein the optical film as described in any one of (1) to (6) is used for at least one of the at least two protective films.

(8) An image display device, comprising:

the optical film as described in any one of (1) to (6) above or the polarizing plate as described in (7) above on the uppermost surface of a display.

(9) A method for manufacturing an optical film including a transparent support and at least one low refractive index layer on or above the transparent support, the method comprising:

applying a composition containing:
(A) a fluorine atom-free polymerizable compound having two or more ethylenically unsaturated groups in one molecule thereof;
(B) low refractive index inorganic fine particles;
(C) a polyrotaxane compound; and
(E) at least two kinds of volatile solvents, on a transparent support, so as to form an applied composition; and

hardening the applied composition to form the low refractive index layer.

(10) The method as described in (9) above,

wherein the composition further contains (D) a polymerization initiator.

(11) The method as described in (9) or (10) above,

wherein the fluorine atom-free polymerizable compound (A) contains an ethylene oxide-modified compound.

(12) The method as described in any one of (9) to (11) above,

wherein the low refractive index inorganic fine particles (B) are inorganic fine particles containing porous or hollow silica as a major component.

(13) The method as described in any one of (9) to (12) above,

wherein the polyrotaxane compound (C) has an ethylenically unsaturated group.

(14) The method as described in any one of (9) to (13) above,

wherein at least two kinds of volatile solvents (E) are a combination of at least two kinds selected from the group consisting of alcohols and derivatives thereof, ethers, ketones, hydrocarbons and esters.

(15) The optical film as described in any one of (1) to (6) above,

wherein a mass ratio of [component (C)/(component (A)+component (C))] in the low refractive index layer is from 3 to 25%.

(16) The method as described in any one of (9) to (14) above,

wherein a mass ratio of [component (C)/(component (A)+component (C))] in the low refractive index layer is from 3 to 25%.

### DETAILED DESCRIPTION OF THE INVENTION

The contents of the invention are hereunder described in detail. In this specification, the term “group” in, for example, an alkyl group, etc., may or may not have a substituent, unless otherwise indicated. Furthermore, in the case of a group whose carbon atom number is limited, the subject carbon atom number means the number also including a carbon atom number which the substituent has.

The optical film of the invention is an optical film comprising a transparent support having thereon at least one low refractive index layer, the low refractive index layer being obtained by hardening a composition containing (A) a fluorine atom-free polymerizable compound having two or more ethylenically unsaturated groups in one molecule thereof (i.e. a polymerizable compound not containing a fluorine atom and having two or more ethylenically unsaturated groups in one molecule thereof); (B) low refractive index inorganic fine particles; and (C) a polyrotaxane compound.

The refractive index of the low refractive index layer of the invention is not particularly limited so far as it is lower by at least 0.01 than the refractive index of the transparent support. It is preferably from 1.25 to 1.48, more preferably from 1.30 to 1.43, and most preferably from 1.30 to 1.40.

The thickness of the low refractive index layer of the invention is not particularly limited. In the case of a low refractive index layer for lowering the reflectance by light interference, the thickness of the low refractive index layer is preferably in the range of from 50 to 500 nm, more preferably in the range of from 60 to 400 nm, and further preferably in the range of from 70 to 350 nm.

First of all, the fluorine atom-free polymerizable compound having two or more ethylenically unsaturated groups in one molecule thereof, which is the component (A) of the invention, is described. The fluorine atom-free polymerizable compound having two or more ethylenically unsaturated groups in one molecule thereof is used for fixing each of the components to be contained in the low refractive index layer, and examples thereof include compounds having a polymerizable functional group such as a (meth)acryloyl group, a vinyl group, a styryl group and an allyl group. Of these, a (meth)acryloyl group is preferable. In particular, the following compounds containing two or more (meth)acryloyl groups in one molecule thereof can be preferably used.

Specific examples of such a polymerizable compound include:

(meth)acrylic diesters of an alkylene glycol such as neopentyl glycol acrylate, 1,6-hexanediol(meth)acrylate and propylene glycol di(meth)acrylate;

(meth)acrylic diesters of a polyoxyalkylene glycol such as triethylene glycol di(meth)acrylate, dipropylene glycol di(meth)acrylate, polyethylene glycol di(meth)acrylate and polypropylene glycol di(meth)acrylate;

(meth)acrylic diesters of a polyhydric alcohol such as pentaerythritol di(meth)acrylate; and

(meth)acrylic diesters of an ethylene oxide or propylene oxide adduct such as 2,2-bis{4-(acryloxy·diethoxy)phenyl}propane and 2,2-bis{4-(acryloxy·polypropoxy)phenyl }propane.

Furthermore, epoxy(meth)acrylates, urethane(meth)acrylates and polyester(meth)acrylates are also preferably used.

Above all, esters of a polyhydric alcohol and (meth)acrylic acid are preferable. Polyfunctional monomers having three or more (meth)acryloyl groups in one molecule thereof are more preferable. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-chlorohexanetetramethacylate, polyurethane polyacrylate, polyester polyacrylate and caprolactone-modified tris(acryloxyethyl)isocyanurate.

Specific compounds of polyfunctional acrylate based compounds having a (meth)acryloyl group include ester compounds of a polyol and (meth)acrylic acid, for example, KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60 and KAYARAD GPO-303, all of which are manufactured by Nippon Kayaku Co., Ltd.; and V#3PA, V#400, V#36095D, V#1000 and V#1080, all of which are manufactured by Osaka Organic Chemical Industry Ltd. Also, trifunctional or polyfunctional urethane acrylate compounds, for example, SHIKO UV-1400B, SHIKO UV-1700B, SHIKO UV-6300B, SHIKO UV-7550B, SHIKO UV-7600B, SHIKO UV-7605B, SHIKO UV-7610B, SHIKO UV-7620EA, SHIKO UV-7630B, SHIKO UV-7640B, SHIKO UV-6630B, SHIKO UV-7000B, SHIKO UV-7510B, SHIKO UV-7461TE, SHIKO UV-3000B, SHIKO UV-3200B, SHIKO UV-3210EA, SHIKO UV-3310EA, SHIKO UV-3310B, SHIKO UV-3500BA, SHIKO UV-3520TL, SHIKO UV-3700B, SHIKO UV-6100B, SHIKO UV-6640B, SHIKO UV-2000B, SHIKO UV-2010B, SHIKO UV-2250EA and SHIKO UV-2750B (all of which are manufactured by The Nippon Synthetic Chemical Industry Co., Ltd.), UL-503LN (manufactured by Kyoeisha Chemical Co., Ltd.), UNIDIC 17-806, UNIDIC 17-813, UNIDIC V-4030 and UNIDIC V-4000BA (manufactured by DIC Corporation), EB-1290K, EB-220, EB-5129, EB-1830 and EB-4858 (all of which are manufactured by Daicel-UCB Company, Ltd.), HI-COAP AU-2010 and HI-COAP AU-2020 (all of which are manufactured by Tokushiki Co., Ltd.), ARONIX M-1960 (manufactured by Toagosei Co., Ltd.) and ART RESIN UN-3320HA, ART RESIN UN-3320HC, ART RESIN UN-3320HS, ART RESIN UN-904 and ART RESIN HDP-4T; and trifunctional or polyfunctional polyester compounds such as ARONIX M-8100, ARONIX M-8030 and ARONIX M-9050 (all of which are manufactured by Toagosei Co., Ltd.) and KRM-8307 (manufactured by Daicel-Cytec company, Ltd.) can be suitably used.

Furthermore, resins having three or more (meth)acryloyl groups, for example, relatively low-molecular weight polyester resins, polyether resins, acrylic resins, epoxy resins, urethane resins, alkyd resins, spiro acetal resins, polybutadiene resins, polythiol polyene resins, oligomers or prepolymers of a polyfunctional compound such as polyhydric alcohols, etc. are exemplified.

As the monomer binder, dendrimers disclosed in, for example, JP-A-2005-76005 and JP-A-2005-36105 and norbornene ring-containing monomers disclosed in, for example, JP-A-2005-60425 can also be used.

The molecular weight of the component (A) of the invention is not particularly limited. From the standpoint of enhancing the compatibility with other components coexisting in the low refractive index layer, the molecular weight of the component (A) of the invention is preferably from 150 to 5,000, and more preferably from 200 to 1,000. These compounds can be used in combination of two or more kinds thereof.

In the case where a linear molecule of the polyrotaxane compound which is the component (C) of the invention as described later is a polyalkylene glycol, it is preferable that at least a part of the compound as the component (A) of the invention is an ethylene oxide-modified monomer having two or more ethylenically unsaturated groups.

In particular, in the case where a linear molecule of the polyrotaxane is polyethylene glycol, it is preferable that at least a part of the component (A) contains an ethylene oxide modified material. When the ethylene oxide modified material is contained, the compatibility with the low refractive index inorganic fine particles which are the component (B) and the polyrotaxane as the component (C) of the invention can be enhanced, and a partial lowering of the gloss on the coating film surface to be caused due to cohesion of the inorganic fine particles or the like can be suppressed, thereby enabling one to contribute to an improvement of the coating surface properties. Also, the content of the low refractive index inorganic fine particles which are the component (B) in the low refractive index layer can be increased, and it is possible to reduce the refractive index of the low refractive index layer and to reduce the reflectance of the optical film.

The amount of the component (A) is preferably from 15 to 50%, and more preferably from 25 to 40% in terms of a mass ratio relative to the total amount of the low refractive index layer-forming components. When the component (A) is used within this range, it is possible to make both a reduction of the refractive index of the low refractive index layer and strength of the coating film compatible with each other.

Next, the low refractive index inorganic fine particles which are the component (B) of the invention are described. The low refractive index inorganic fine particles to be used in the low refractive index layer of the invention are inorganic fine particles having a refractive index of from 1.10 to 1.48. The refractive index of the low refractive index inorganic fine particles is preferably from 1.10 to 1.46, and more preferably from 1.15 to 1.32.

The inorganic fine particles may be either crystalline or amorphous; and it may be monodispersed particles or cohered particles. The size of the inorganic fine particles is preferably from 1 to 150 nm, more preferably from 5 to 100 nm, and most preferably from 5 to 80 nm. In the case of cohered particles, the particle size as referred to herein refers to the size of a secondary particle. The particle size is measured by a scanning electron microscope. Plural particles of two or more kinds (kind or particle size) may be used. Though the shape of the particle is most preferably spherical, even when it is amorphous, it does not matter.

The low refractive index inorganic fine particles which are used in the invention is preferably particles composed of, as a major component, silica or inorganic fluoride particles. Particles containing, as a major component, porous or hollow silica or inorganic fluoride particles are more preferable, and hollow silica particles are further preferable.

Examples of the inorganic fluoride particles include aluminum fluoride (refractive index: 1.38), calcium fluoride (refractive index: from 1.23 to 1.45), lithium fluoride (refractive index: 1.30) and magnesium fluoride (refractive index: from 1.38 to 1.40). Of these, lithium fluoride, calcium fluoride and magnesium fluoride are preferable; and magnesium fluoride is especially preferable. Magnesium fluoride is the most preferable from the standpoints of particle hardness, hygroscopicity and refractive index. Examples of commercially available magnesium fluoride which can be used include magnesium fluoride, magnesium fluoride OP, magnesium fluoride G1 and magnesium fluoride H, all of which are manufactured by Stella Chemifa Corporation; and magnesium fluoride, manufactured by Sanwa Kenma Ltd.

The particles containing, as a major component, porous or hollow silica has 60% by mass or more of silica and may contain, as a subsidiary component, aluminum oxide, tin oxide, antimony oxide, etc. (In this specification, mass ratio is equal to weight ratio.)

A preferred manufacturing method of hollow fine particles includes the following steps. That is, a first stage is the formation of core particles which can be removed by post-treatment; a second stage is the formation of a shell layer; and a third stage is the dissolution of core particles. If desired, the formation of an additional shell phase is included as a fourth stage. Specifically, the manufacture of hollow particles can be carried out according to a manufacturing method of hollow silica fine particles disclosed in, for example, JP-A-2001-233611.

A preferred manufacturing method of porous particles is a method including a first stage of manufacturing porous core particles by controlling the degree of hydrolysis or condensation of an alkoxide and the kind or amount of a coexisting material and a second stage of forming a shell layer on the surface thereof. Specifically, the manufacture of porous particles can be carried out by a method disclosed in, for example, JP-A-2003-327424, JP-A-2003-335515, JP-A-2003-226516, JP-A-2003-238140, etc.

In the invention, hollow silica particles are preferable from the standpoint that the ability for reducing the refractive index is high. One having a refractive index ranging from 1.15 to 1.32 and a particle size ranging from 20 to 90 nm can be suitably used.

The low refractive index inorganic fine particles may be used upon being dispersed in an organic solvent. Examples of the organic solvent which can be used as a dispersion medium include alcohols such as methanol, ethanol, isopropyl alcohol, ethylene glycol, butanol and ethylene glycol monopropyl ether; ketones such as acetone, methyl ethyl ketone and methyl isobutyl ketone; aromatic hydrocarbons such as toluene and xylene; amides such as dimethylformamide, dimethylacetamide and N-methylpyrrolidone; esters such as ethyl acetate, butyl acetate and γ-butyrolactone; and ethers such as diethyl ether, tetrahydrofuran and 1,4-dioxane. Of these, alcohols and ketones are preferable. These organic solvents can be used as a dispersion medium singly or in admixture of two or more kinds thereof.

Also, for the purpose of enhancing the dispersibility, it is preferred to subject the surface of the inorganic fine particles to a surface treatment such as chemical modification. For example, it can be allowed to react with a hydrolyzable silicon compound having one or more alkyl groups in a molecule thereof or a hydrolyzate thereof. Examples of such a hydrolyzable silicon compound include trimethylmethoxysilane, tributylmethoxysilane, dimethyldimethoxysilane, dibutyldimethoxysilane, methyltrimethoxysilane, butyltrimethoxysilane, octyltrimethoxysilane, dodecyltrimethoxysilane, 1,1,1-trimethoxy-2,2,2-trimethyl-disilane, hexamethyl-1,3-disiloxane, 1,1,1-trimethoxy-3,3,3-trimethyl-1,3-disiloxane, α-trimethylsilyl-ω-dimethylmethoxysilyl-polydimethylsiloxane, α-trimethylsilyl-ω-trimethoxysilyl-polydimethylsiloxane and hexamethyl-1,3-disilazane.

Also, it is preferable that the inorganic fine particles are subjected to a surface treatment in the presence of an acid catalyst or a metal chelate compound disclosed in JP-A-2005-307158; and it is especially preferable that the inorganic fine particles are treated with an ethylenically unsaturated bond-containing organosilane compound. The compound is suitably (meth)acryloyloxypropyltrimethoxysilane.

In the invention, the content of the low refractive index inorganic fine particles as the component (B) is preferably from 50 to 85%, and more preferably from 60 to 75% in terms of a mass ratio relative to the total amount of the low refractive index layer-forming components excluding the coating solvent. When the component (B) is used within this range, it is possible to make both a reduction of the refractive index of the low refractive index layer and strength of the coating film compatible with each other. When the polyrotaxane which is the component (C) of the invention is not used, the content of the component (B) increases, and the deterioration of the strength of the coating film in a region where the particles have a structure close to a close-packed structure is remarkable.

Next, the polyrotaxane compound which is the component (C) of the invention is described. The polyrotaxane is one having a blocking group disposed at the both end terminals (both end terminals of a linear molecule) of a pseudo polyrotaxane in which an opening of a cyclic molecule is penetrated in a pierced state by a linear molecule, and plural cyclic molecules include the linear molecule, the blocking group servicing to prevent the cyclic molecule from leaving.

### (Linear Molecule)

The linear molecule included in the compound of the invention is a molecule or a material capable of being included in a cyclic molecule and integrated in a non-covalent bonding manner therewith and is not particularly limited so far as it is linear. The term “linear molecule” as referred to in the invention refers to molecules including polymers and all of other materials which meet the foregoing requirement.

Also, it is meant by the term “linear” of the “linear molecule” that it is substantially “linear”. That is, so far as the cyclic molecule as a rotator is rotatable, or the cyclic molecule is slidable or movable on the linear molecule, the linear molecule may have a branched chain. Also, the length of “linear” is not particularly limited so far as the cyclic molecule is slidable or movable on the linear molecule.

Examples of the linear molecule of the invention include hydrophilic polymers, for example, polyvinyl alcohol, polyvinylpyrrolidone, poly(meth)acrylic acid, cellulose based resins (for example, carboxymethyl cellulose, hydroxyethyl cellulose, hydroxypropyl cellulose, etc.), polyacrylamide, polyethylene oxide, polyethylene glycol, polyvinyl acetal based resins, poly(vinyl methyl ether), polyamines, polyethyleneimine, casein, gelatin, starch, etc., and/or copolymers thereof; hydrophobic polymers, for example, polyolefin based resins such as polyethylene, polypropylene and copolymer resins thereof with other olefin based monomer, polyester resins, polyvinyl chloride resins, polystyrene based resins such as polystyrene and acrylonitrile-styrene copolymer resins, acrylic resins such as polymethyl methacrylate, (meth)acrylic acid ester copolymers and acrylonitrile-methyl acrylate copolymer resins, polycarbonate resins, polyurethane resins, vinyl chloride-vinyl acetate copolymer resins, polyvinyl butyral resins, etc.; and derivatives or modified materials thereof.

Of these, hydrophilic polymers are preferable. Such a hydrophilic polymer is effective for improving the dispersibility of the low refractive index inorganic fine particles to be contained in the low refractive index layer and improving the surface properties of a coating film.

Of the hydrophilic polymers, polyethylene glycol, polypropylene glycol, a copolymer of polyethylene glycol and polypropylene glycol, polyisoprene, polyisobutylene, polybutadiene, polytetrahydrofuran, polydimethylsiloxane, polyethylene and polypropylene are preferable. Polyethylene glycol, polypropylene glycol and a copolymer of polyethylene glycol and polypropylene glycol are more preferable; and polyethylene glycol is especially preferable.

It is desirable that the linear molecule of the invention has high breaking strength by itself. Though the breaking strength of the low refractive index layer depends upon other factors such as bonding strength between the blocking group and the linear molecule, bonding strength between the cyclic molecule and a binder of the low refractive index layer and bonding strength between cyclic molecules each other, it is possible to provide higher breaking strength so far as the linear molecule of the invention has high breaking strength by itself.

The molecular weight of the linear molecule of the invention is 1,000 or more, for example, from 1,000 to 1,000,000; preferably 5,000 or more, for example, from 5,000 to 1,000,000, or from 5,000 to 500,000; and more preferably 10,000 or more, for example, from 10,000 to 1,000,000, from 10,000 to 500,000 or from 10,000 to 300,000. Also, the linear molecule of the invention is preferably a biodegradable molecule from the standpoint of “environmentally friendly”.

It is preferable that the linear molecule of the invention has a reactive group at the both end terminals thereof. When the linear molecule has this reactive group, it is able to easily react with the blocking group. Though the reactive group depends upon the blocking group to be used, examples thereof include a hydroxyl group, an amino group, a carboxyl group and a thiol group.

### (Cyclic Molecule)

As the cyclic molecule of the invention, any cyclic compound can be used so far as it is a cyclic molecule capable of undergoing inclusion with the foregoing linear molecule.

The “cyclic molecule” as referred to in the invention refers to a cyclic material of every sort including cyclic molecules. Also, the “cyclic molecule” as referred to in the invention refers to a molecule or a material which is substantially cyclic. That is, it is meant by the terms “substantially cyclic” that one in which the ring is not completely closed as in an English letter “C” is included; and that one having a helical structure in which one end and the other end of an English letter “C” are not bonded to each other but are superimposed is also included. Furthermore, the ring regarding a “bicyclic molecule” as described later can be similarly defined as in the terms “substantially cyclic” of the “cyclic molecule”. That is, either one or both of the rings of the “bicyclic molecule” may be one in which the ring is not completely closed as in an English letter “C” or may be one having a helical structure in which one end and the other end of an English letter “C” are not bonded to each other but are superimposed.

Examples of the cyclic molecule of the invention include various cyclodextrins (for example, α-cyclodextrin, β-cyclodextrin, γ-cyclodextrin, dimethylcyclodextrin and glucosylcyclodextrin, derivatives or modified materials thereof, etc.), crown ethers, benzocrowns, dibenzocrowns and bicyclohexanocrowns; and derivatives and modified materials thereof.

The foregoing cyclodextrins and crown ethers are different in the size of an opening of the cyclic molecule depending upon the kind thereof. Accordingly, the cyclic molecule to be used can be chosen depending upon the kind of the linear molecule to be used, specifically in the case of likening the linear molecule as a column, the diameter of a cross section of the column, hydrophobicity or hydrophilicity of the linear molecule, and the like. Also, in the case of using a cyclic molecule having a relatively large opening and a columnar linear molecule having a relatively small diameter, two or more linear molecules can be included in the opening of the cyclic molecule. Of these, the cyclodextrins are preferable from the standpoint of the foregoing “environmentally friendly” because they are biodegradable.

It is preferred to use α-cyclodextrin as the cyclic molecule.

In the case where the cyclic molecule is a cyclodextrin, when its maximum inclusion amount is defined to be 1, the number (inclusion amount) of the cyclic molecule to be included in the linear molecule is preferably from 0.05 to 0.60, more preferably from 0.10 to 0.50, and further preferably from 0.20 to 0.40. When the number of the cyclic molecule is less than 0.05, there is a concern that a pulley effect does not reveal. On the other hand, when it exceeds 0.60, there is a concern that the cyclodextrin which is a cyclic molecule is excessively densely disposed so that the movability of the cyclodextrin is lowered; and there is a concern that the non-solubility of the cyclodextrin itself in an organic solvent is strengthened so that the solubility of the obtained polyrotaxane in an organic solvent is lowered.

It is preferable that the cyclic molecule of the invention has a reactive group outside the ring thereof. In bonding or crosslinking the cyclic molecules with each other, the reaction can be easily carried out using this reactive group. Though the reactive group depends upon a crosslinking agent to be used or the like, examples thereof include a hydroxyl group, an amino group, a carboxyl group, a thiol group and an aldehyde group. Also, in conducting the foregoing blocking reaction, it would be better to use a group which is not reactive with the blocking group.

### (Blocking Group)

As the blocking group of the invention, any group may be used so far as it is a group capable of holding a form in which the cyclic molecule is in a pierced state by the linear molecule. Examples of such a group include a group with “bulkiness” and/or a group with “ionicity”. The term “group” as referred to herein means various groups including molecular groups and polymer groups. Also, when the “ionicity” of the group with “ionicity” and the “ionicity” which the cyclic molecule has have a mutual influence on each other, for example, they repel each other, the cyclic molecule can hold a form in which it is in a pierced state by the linear molecule.

Also, the blocking group of the invention may be a principal chain or a side chain of a polymer so far as it holds a form in which it is in a pierced state as described previously. In the case where the blocking group is a polymer A, there may be a form in which the polymer A serves as a matrix, and the compound of the invention is included in a part thereof; or a form in which the compound of the invention inversely serves as a matrix, and the polymer A is included in a part thereof. In this way, by combining with the polymer A having various properties, a complex material having a combination of properties of the compound of the invention and properties of the polymer A can be formed.

Specifically, examples of the blocking group of the molecular group include dinitrophenyl groups such as a 2,4-dinitrophenyl group and a 3,5-dinitrophenyl group, cyclodextrins, adamantane groups, trityl groups, fluoresceins and pyrenes, and derivatives or modified materials thereof. More specifically, even in the case of using α-cyclodextrin as the cyclic molecule and polyethylene glycol as the linear molecule, respectively, there can be exemplified cyclodextrins, dinitrophenyl groups such as a 2,4-dinitrophenyl group and a 3,5-dinitrophenyl group, adamantane groups, trityl groups, fluoresceins and pyrenes, and derivatives or modified materials thereof.

Next, the modified polyrotaxane which can be preferably used in the invention is described. In the invention, a polyrotaxane in which plural modifications as described below are used in combination can be preferably used.

### <Crosslinked Polyrotaxane>

The crosslinked polyrotaxane refers to a compound in which two or more polyrotaxanes are chemically bonded to each other as to cyclic molecules thereof, and the two cyclic molecules may be the same or different. On that occasion, the chemical bond may be merely a bond or may be a bond via various atoms or molecules.

Also, a molecule in which the cyclic molecule has a crosslinked ring structure, namely a “bicyclic molecule” having first and second rings can be used. In that case, for example, the crosslinked polyrotaxane can be obtained by mixing the “bicyclic molecule” and the linear molecule and including the linear molecule in a pierced state in the first ring and second ring of the “bicyclic molecule”.

Since the cyclic molecule which is penetrated in a pierced state into the linear molecule is movable along the linear molecule (pulley effect), this crosslinked polyrotaxane has viscoelasticity, and even when a tension is applied, it is able to uniformly disperse the tension and relax an internal stress due to this pulley effect.

### <Hydrophilized Modified Polyrotaxane>

In the case where the cyclic molecule of the polyrotaxane is a cyclodextrin such as α-cyclodextrin, a hydrophobilized modified polyrotaxane in which at least one hydroxyl group of the cyclodextrin is substituted with other organic group (hydrophobic group) is more preferably used in the invention because its solubility in the solvent which is contained in the low refractive index layer forming composition is enhanced.

Specific examples of the hydrophobic group include an alkyl group, a benzyl group, a benzene derivative-containing group, an acyl group, a silyl group, a trityl group, a nitric acid ester group and a tosyl group; examples of a photohardenable site include an alkyl-substituted ethylenically unsaturated group; and examples of a heat hardenable site include an alkyl-substituted epoxy group. However, it should not be construed that the invention is limited thereto. Also, in the foregoing hydrophobilized modified polyrotaxane, the foregoing hydrophobic group may be used singly or in combination of two or more kinds thereof.

When the maximum number of the hydroxyl group of the cyclodextrin which can be modified is defined to be 1, the degree of modification of the foregoing hydrophobic modifying group is preferably 0.02 or more, more preferably 0.04 or more, and further preferably 0.06 or more.

When the degree of modification of the hydrophobic modifying group is less than 0.02, the solubility in the organic solvent is not sufficient, and there is a concern that an insoluble hard spot (a projection derived from the attachment of a foreign matter) is formed.

In other words, the maximum number of the hydroxyl group of the cyclodextrin which can be modified as referred to herein means the total number of hydroxyl groups which the cyclodextrin has prior to the modification. In other words, the degree of modification as referred to herein means a ratio of the number of the modified hydroxyl group to the total number of hydroxyl groups.

The number of the hydrophobic group may be at least one. In that case, it is preferable that the dextrin has one hydrophobic group relative to one dextrin ring.

Also, by introducing a functional group-containing hydrophobic group, it is possible to enhance the reactivity with other polymer.

### <Polyrotaxane Having an Unsaturated Double Bond>

An unsaturated bonding group can be introduced into a moiety corresponding to the cyclic molecule. By introducing this group, it is possible to carry out polymerization with a fluorine atom-free polymerizable compound which is the component (A).

The introduction of an unsaturated bonding group can be carried out by, for example, substituting at least a part of the cyclic molecule having a hydroxyl group (—OH), such as cyclodextrins, with an unsaturated bonding group, preferably an unsaturated double bonding group.

Examples of the unsaturated bonding group, for example, an unsaturated double bonding group, include an olefinyl group; and examples thereof include an acryl group, a methacryl (methacryloyl) group, a vinyl ether group and a styryl group. However, it should not be construed that the invention is limited thereto.

For introducing an unsaturated double bonding group, the following method can be adopted. That is, there can be exemplified a method by the carbamate bond formation by an isocyanate compound, etc.; a method by the ester bond formation by a carboxylic acid compound, an acid chloride compound or an acid anhydride, etc.; a method by the silyl ether bond formation by a silane compound, etc.; and a method by the carbonate bond formation by a chlorocarbonic acid compound, etc.

In the case of introducing a methacryloyl group as the unsaturated double bonding group via a carbamoyl bond, the introduction is carried out by dissolving a polyrotaxane in a dehydrated solvent such as DMSO and DMF and adding an isocyanate group-containing methacryloyl reagent thereto. Besides, in the case of carrying out the introduction via an ether bond or an ester bond, a methacryloyl reagent having an active group such as a glycidyl group and an acid chloride can be used, too.

A step in which the hydroxyl group which the cyclic molecule has is substituted with an unsaturated double bonding group may be provided before, during or after a step of preparing a pseudo polyrotaxane. Also, the substitution step may be provided before, during or after a step of blocking a pseudo polyrotaxane to prepare a polyrotaxane. Furthermore, in the case where the polyrotaxane is a crosslinked polyrotaxane, the substitution step may be provided before, during or after a step of crosslinking polyrotaxanes with each other. The substitution step may be provided at two or more of these times. It is preferred to provide the substitution step after blocking a pseudo polyrotaxane to prepare a polyrotaxane and before crosslinking polyrotaxanes with each other. Though the condition to be required in the substitution step depends upon the unsaturated double bonding group to be substituted, it is not particularly limited. Various reaction methods and reaction conditions can be adopted.

As to the content of the polyrotaxane which is the component (C) in the invention, in terms of a ratio with the component (A) in the low refractive index layer, % by mass of [component (C)/(component (A)+component (C))] is preferably from 1 to 35%, more preferably from 3 to 25%, and most preferably from 6 to 20%. When the component (C) is used within this range, it is possible to make both the dispersibility of the low refractive index inorganic fine particles coexisting in the low refractive index layer and the strength of a coating film of the low refractive index layer after hardening compatible with each other.

In the invention, the polyrotaxane which is used is preferably a hydrophobilized modified polyrotaxane, and more preferably a polyrotaxane having an unsaturated double bond.

Next, the polymerization initiator which is the component (D) of the invention is described. Hardening of the low refractive index layer of the invention can be carried out upon irradiation with ionizing radiations or by heating in the presence of the polymerization initiator which is the component (D).

### (Photo Radical Initiator)

Examples of the photo radical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogen compounds, inorganic complexes and coumarins.

Examples of the acetophenones include 2,2-dimethoxyacetophenone, 2,2-diethoxyacetophenone, p-dimethylacetophenone, 1-hydroxy-dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone and 4-t-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzopheone (Michler's ketone) and 3,3′,4,4′-tetra(t-butylperoxycarbonyl)benzophenone.

Examples of the phosphine oxides include 2,4,6-trimethylbenzoyl diphenylphosphine oxide. Examples of the active esters include 1,2-octanedione, 1-[4-(phenylthio)-2-(O-benzoyloxime)], sulfonic acid esters and cyclic active ester compounds. Specifically, Compounds 1 to 21 disclosed in the working examples of JP-A-2000-80068 are especially preferable.

Examples of the onium salts include aromatic diazonium salts, aromatic iodonium salts and aromatic sulfonium salts. Examples of the borate salts include ion complexes with a cationic dye.

As examples of the active halogens, known s-triazine or oxathiazole compounds are known. Examples thereof include 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloromethyl)-s-triazine and a 2-trihalomethyl-5-(p-methoxyphenyl)-1,3,4-oxadiazole. Specifically, compounds disclosed in JP-A-58-15503, pages 14 to 30 and JP-A-55-77742, pages 6 to 10; Compound Nos. 1 to 8 disclosed in JP-B-60-27673, page 287; Compound Nos. 1 to 17 disclosed in JP-A-60-239736, pages 443 to 444; and Compound Nos. 1 to 19 of U.S. Pat. No. 4,701,399.

Also, an oligomer type ultraviolet ray polymerization initiator containing plural polymerization initiation sites in one molecule thereof can be used. Specific examples thereof include poly[2-hydroxy-2-methyl-1-[4-(1-methylvinyl)phenyl]propanone], poly[2-hydroxy-2-methyl-1-[4-vinyl-phenyl]propanone], poly[2-hydroxy-2-ethyl-1-[4-(1-methylvinyl)phenyl]propanone], poly[2-hydroxy-2-ethyl-1-[4-vinyl-phenyl]propanone, poly[2-hydroxy-2-methyl-1-[4-(1-methylvinyl)phenyl]butanone], poly[2-hydroxy-2-methyl-1-[4-vinyl-phenyl]butanone], poly[2-hydroxy-2-ethyl-1-[4-(1-methylvinyl)phenyl]butanone] and poly[2-hydroxy-2-ethyl-1-[4-vinyl-phenyl]butanone].

A variety of examples are described in Saishin UV Koka Gijutsu (Latest UV Curing Technologies), published by Technical Information Institute Co., Ltd., page 159 (1991) and Kiyoshi Kato, Shigaisen Koka Shisutemu (Ultraviolet Ray Curing Systems), published by Sogo Gijutsu Center, pages 65 to 148 (1988) are useful in the invention.

As a commercially available photo cleavage type photo radical polymerization initiator, “IRGACURE 127”, “IRGACURE 184”, “IRGACURE 651”, “IRGACURE 819”, “IRGACURE 907”, “IRGACURE 1870” (a mixed initiator of CGI-403 and Irg 184 (7/3)), “IRGACURE 500”, “IRGACURE 369”, “IRGACURE 1173”, “IRGACURE 2959”, “IRGACURE 4265”, “IRGACURE 4263” and “OXE 01”, all of which are manufactured by Ciba Specialty Chemicals; “KAYACURE DETX-S”, “KAYACURE BP-100”, “KAYACURE BDMK”, “KAYACURE CTX”, “KAYACURE BMS”, “KAYACURE 2-EAQ”, “KAYACURE ABQ”, “KAYACURE CPTX”, “KAYACURE EPD”, “KAYACURE ITX”, “KAYACURE QTX”, “KAYACURE BTC” and “KAYACURE MCA”, all of which are manufactured by Nippon Kayaku Co., Ltd.; and ESACURE Series as manufactured by Sartomer Company Inc. (for example, KIP100F, KB1, EB3, BP, X33, KTO46, KT37, KIP150 and TZT) and combinations thereof are enumerated as preferred examples.

In addition of the photopolymerization initiator, a photosensitizer may be used. Examples of the photosensitizer include n-butylamine, triethylamine, tri-n-butylphosphine, Michler's ketone and thioxanthone. Further, at least one of auxiliary agents such as an azide, a thiourea compound and a mercapto compound may be used in combination with them.

With respect to commercially available photosensitizers, there are enumerated “KAYACURE DMBI” and “KAYACURE EPA” as manufactured by Nippon Kayaku Co., Ltd.

### (Heat Radical Initiator)

Examples of a heat radical initiator which can be used include organic or inorganic peroxides, and organic azo or diazo compounds.

Specifically, examples of the organic peroxides include benzoyl peroxide, halogen benzoyl peroxides, lauroyl peroxide, acetyl peroxide, dibutyl peroxide, cumene hydroperoxide and butyl hydroperoxide; examples of the inorganic peroxides include hydrogen peroxide, ammonium persulfate and potassium persulfate; examples of the azo compounds include 2,2′-azobis(isobutyronitrile), 2,2′-azobis(propionitrile) and 1,1′-azobis(cyclohexanecarbonitrile); and examples of the diazo compounds include diazoaminobenzene and p-nitrobenzene diazonium.

The content of the polymerization initiator which is the component (D) in the invention is preferably in the range of from 0.1 to 15 parts by mass, and more preferably in the range of from 1 to 10 parts by mass based on 100 parts by mass of the component (A) in the low refractive index layer. When the component (D) is used within this range, it is possible to make both the dispersibility of the low refractive index inorganic fine particles coexisting in the low refractive index layer and the strength of a coating film of the low refractive index layer after hardening compatible with each other.

In the invention, from the viewpoint of enhancing the antifouling properties, it is further preferred to reduce the surface free energy of the surface of the low refractive index layer. Specifically, it is preferred to use a fluorine-containing compound or a compound having a polysiloxane structure in the low refractive index layer.

It is also preferred to add, as an additive having a polysiloxane structure, a reactive group-containing polysiloxane {for example, “KF-100T”, “X-22-169AS”, “KF-102”, “X-22-3701IE”, “X-22-164B”, “X-22-5002”, “X-22-173B”, “X-22-174D”, “X-22-167B” and “X-22-161AS” (trade names, as manufactured by Shin-Etsu Chemical Co., Ltd.); “AK-5”, “AK-30” and “AK-32” (trade names, as manufactured by Toagosei Co., Ltd.); “SILAPLANE FM0275” and “SILAPLANE FM0721”, all of which are manufactured by Chisso Corporation; and “RMS-033” which is a trade name, as manufactured by Gelest, Inc.}. Also, silicone based compounds disclosed in Tables 2 and 3 of JP-A-2003-112383 can be preferably used. In that case, the polysiloxane is preferably added in an amount in the range of from 0.1 to 10% by mass, and especially preferably in the range of from 1 to 5% by mass relative to the whole of solids of the low refractive index layer.

The composition for forming the low refractive index layer of the invention can be a coating composition obtained by further adding (E) a volatile solvent to the components (A), (B), (C) and (D) components according to the invention. Though the solvent of the coating composition is not limited, it is preferable that at least two kinds of volatile solvents are contained. For example, it is preferred to use a combination of at least two kinds selected among alcohols and derivatives thereof, ethers, ketones, hydrocarbons and esters. The solvent can be chosen from the viewpoints of solubility of a binder component, stability of the inorganic fine particles, regulation of the viscosity of a coating solution and the like.

It is especially preferred to use a combination of at least two kinds, and more preferably three kinds selected among alcohols and derivatives thereof, ketones and esters. As a preferred example, a combination of two kinds or three kinds selected among methyl ethyl ketone, methyl isobutyl ketone, cyclohexanone, 2-methoxypropanol, 2-butoxyethanol, isopropyl alcohol and toluene can be used. It is preferable that at least one kind of the two solvents is a solvent having a boiling point of 100° C. or higher and not higher than 250° C., and more preferably 100° C. or higher and not higher than 200° C. When a solvent having a boiling point falling within this range is contained, the volatilization of the solvent from the coating composition becomes an appropriate rate, the polyrotaxane stabilizes the low refractive index inorganic fine particles in the coating composition, and the surface properties of the coating film are improved.

In the case of forming the low refractive index layer by coating, an optimal viscosity of the coating composition for low refractive index layer of the invention is preferably from 0.1 to 20 mPa·s, and more preferably from 0.5 to 10 mPa·s (25° C.).

### (Layer Configuration of Optical Film)

The optical film (antireflection film) of the invention is composed of a stack of at least one low refractive index layer on a transparent support (hereinafter also referred to as “support”) while taking into consideration the refractive index, the thickness, the number of layers, the layer order, and so on.

In general, in the optical film of the invention, the simplest configuration is a configuration in which only a low refractive index layer is coated on a support. In order to further lower the reflectance, it is preferable that the antireflection layer is configured by combining a high refractive index layer having a higher refractive index than the support and a low refractive index layer having a lower refractive index than the substrate. Examples of the configuration include a stack made of two layers of a high refractive index layer and a low refractive index layer; a stack made of three layers having a different refractive index of a middle refractive index layer (a layer having a higher refractive index than the substrate or hard coat layer and having a lower refractive index than a high refractive index layer), a high refractive index layer and a low refractive index layer in this order from the substrate side. There is also proposed a stack having more antireflection layers. Above all, in view of durability, optical characteristics, costs, productivity, and so on, it is preferable that a middle refractive index layer, a high refractive index layer and a low refractive index layer are coated in this order on a substrate having a hard coat layer.

Also, in the invention, in order to enhance the pencil hardness of the optical film, it is preferable that at least one optical layer is provided between the low refractive index layer and the support. From the standpoints of increasing the hardness of the optical layer itself and strengthening the bond at an interface to the low refractive index layer, the optical film is preferably one obtained by hardening a composition containing the component (A) which is the constitutional component of the low refractive index layer.

Examples of the preferred layer configuration of the optical film of the invention will be given below. In the following configurations, the terms “(antistatic layer)” refer to a configuration in which a layer having other function also has a function as the antistatic layer. The configuration in which the antistatic layer has other function than the antistatic function is enhanced in the productivity and is therefore preferable because the number of layers to be formed can be reduced.
Support/antistatic layer/low refractive index layer
Support/low refractive index layer (antistatic layer)
Support/antiglare layer (antistatic layer)/low refractive index layer
Support/antiglare layer/antistatic layer/low refractive index layer
Support/hard coat layer/antiglare layer (antistatic layer)/low refractive index layer
Support/hard coat layer/antiglare layer/antistatic layer/low refractive index layer
Support/hard coat layer/antistatic layer/antiglare layer/low refractive index layer
Support/hard coat layer (antistatic layer)/antiglare layer/low refractive index layer
Support/hard coat layer/high refractive index layer/antistatic layer/low refractive index layer
Support/hard coat layer/high refractive index layer (antistatic layer)/low refractive index layer
Support/hard coat layer/antistatic layer/high refractive index layer/low refractive index layer
Support/hard coat layer/middle refractive index layer/high refractive index layer (antistatic layer)/low refractive index layer
Support/hard coat layer/middle refractive index layer (antistatic layer)/high refractive index layer/low refractive index layer
Support/hard coat layer (antistatic layer)/middle refractive index layer/high refractive index layer/low refractive index layer
Support/antiglare layer/high refractive index (antistatic layer)/low refractive index layer
Support/antiglare layer/middle refractive index layer (antistatic layer)/high refractive index layer/low refractive index layer
Support/antistatic layer/hard coat layer/middle refractive index layer/high refractive index layer/low refractive index layer
Antistatic layer/support/hard coat layer/middle refractive index layer/high refractive index layer/low refractive index layer
Support/antistatic layer/antiglare layer/middle refractive index layer/high refractive index layer/low refractive index layer
Antistatic layer/support/antiglare layer/middle refractive index layer/high refractive index layer/low refractive index layer
Antistatic layer/support/antiglare layer/high refractive index layer/low refractive index layer/high refractive index layer/low refractive index layer

So far as the reflectance by optical interference can be reduced, it should not be construed that the optical film of the invention is limited only to these layer configurations.

The support of the film of the invention is not particularly limited, and examples thereof include transparent resin films, transparent resin plates, transparent resin sheets and transparent glasses. Examples of the transparent resin film which can be used include cellulose acylate films (for example, a cellulose triacetate film (refractive index: 1.48), a cellulose diacetate film, a cellulose acetate butyrate film and a cellulose acetate propionate film), polyethylene terephthalate films, polyethersulfone films, polyacrylic resin films, polyurethane based resin films, polyester films, polycarbonate films, polysulfone films, polyether films, polymethyl pentene films, polyetherketone films, (meth)acrylonitrile films and cycloolefin based resin films.

Of these, cellulose acylate films, polyethylene terephthalate films and cycloolefin based resin films are preferable.

The low refractive index layer of the invention can be formed in the following coating method, but it should not be construed that the invention is limited to this method.

There are adopted known methods such as a dip coating method, an air knife coating method, a curtain coating method, a roller coating method, a wire bar coating method, a gravure coating method, an extrusion coating method (die coating method) (see U.S. Pat. No. 2,681,294) and a microgravure coating method. Of these, a microgravure coating method and a die coating method are preferable.

In order to feed the film of the invention with high productivity, an extrusion method (die coating method) is preferably adopted. In particular, this method can be preferably adopted in a region where the wet coating amount is low (not more than 20 cm³/m²).

It is preferable that after coating the low refractive index layer, the film of the invention is conveyed into a zone heated for drying the solvent by means of a web.

The temperature of the drying zone is preferably from 25° C. to 140° C.; and it is preferable that the temperature of the first half of the drying zone is relatively low, whereas the temperature of the second half of the drying zone is relatively high.

Also, as to the dry air after coating the coating composition of each layer on the support, when the solids content of the coating composition is from 1 to 50%, it is preferable that the air velocity on the surface of the coating film is in the range of from 0.1 to 2 m/sec for the purpose of preventing drying unevenness from occurring.

Also, after coating the coating composition of each layer on the support, when a difference in the temperature between a conveyance roll coming into contact with the opposite surface of the support to the coating surface is made to fall within the range of from 0° C. to 20° C. in the drying zone, drying unevenness due to heat transmission unevenness on the conveyance roll can be prevented from occurring, and therefore, such is preferable.

After drying the solvent, the film of the invention is passed through a zone capable of hardening each coating film by ionizing radiations and/or heat by the web, whereby the coating film can be hardened.

In the invention, the species of the ionizing radiations is not particularly limited and can be properly selected among ultraviolet rays, electron beams, near ultraviolet rays, visible light, near infrared rays, infrared rays and X-rays depending upon the kind of the hardenable composition from which a film is formed. Above all, ultraviolet rays and electron beams are preferable; and ultraviolet rays are especially preferable from the standpoints that handling is simple and easy and that high energy is easily obtained.

As a light source of ultraviolet rays for photopolymerizing an ultraviolet ray reactive compound, any light source can be used so far as it is able to emit ultraviolet rays. For example, a low pressure mercury vapor lamp, a middle pressure mercury vapor lamp, a high pressure mercury vapor lamp, an extra-high pressure mercury vapor lamp, a carbon arc lamp, a metal halide lamp, a xenon lamp and so on can be used. Furthermore, an ArF excimer laser, a KrF excimer laser, an excimer lamp, a synchrotron radiation and so on can be used, too. Above all, an extra-high pressure mercury vapor lamp, a high pressure mercury vapor lamp, a low pressure mercury vapor lamp, a carbon arc lamp, a xenon arc lamp and a metal halide lamp can be preferably used.

Also, electron beams can be similarly used. As the electron beams, there can be enumerated electron beams having energy of from 50 to 1,000 keV, and preferably from 100 to 300 keV, which are emitted from a variety of electron beam accelerators such as a Cockcroft-Walton type electron beam accelerator, a van de Graaff type electron beam accelerator, a resonant transformation type electron beam accelerator, an insulating core transformer type electron beam accelerator, a linear type electron beam accelerator, a dynamitron type electron beam accelerator and a high frequency type electron beam accelerator.

The irradiation condition varies depending upon the respective lamp. An irradiation dose is preferably 10 mJ/cm² or more, more preferably from 50 mJ/cm² to 10,000 mJ/cm², and especially preferably from 50 mJ/cm² to 2,000 mJ/cm². On that occasion, the irradiation dose distribution in the width direction of the web including the both ends is preferably from 50 to 100%, and more preferably from 80 to 100% on the basis of a maximum irradiation dose in the center.

In the invention, it is preferred to harden at least one layer stacked on the support by a step of irradiating ionizing radiations in an atmosphere having an oxygen concentration of not more than 10% by volume in a state of irradiating ionizing radiation and heating at a film surface temperature of 60° C. or higher for a period of time of 0.5 seconds or more after starting the irradiation with ionizing radiations.

It is also preferable that heating is carried out in an atmosphere having an oxygen concentration of not more than 3% by volume simultaneously with and/or continuously to the irradiation with ionizing radiations. In particular, it is preferable that the low refractive index layer having a thin thickness is hardened by this method. The hardening reaction is accelerated by heat, whereby a film having excellent physical strength and chemical resistance can be formed.

The time for irradiating ionizing radiations is preferably 0.7 seconds or more and not more than 60 seconds, and more preferably 0.7 seconds or more and not more than 10 seconds. When the time for irradiating ionizing radiations is 0.7 seconds or more, the hardening reaction is completed so that hardening can be thoroughly achieved. Also, when the time for irradiating ionizing radiations is not more than 60 seconds, it is not necessary to keep the low oxygen condition for a long period of time. Therefore, such is excellent from the viewpoints that an increase in the size of equipment can be avoided and that a large amount of an inert gas is not necessary.

It is preferable that a film is formed in an atmosphere having an oxygen concentration of not more than 6% by volume by a crosslinking reaction or polymerization reaction of the ionizing radiation hardenable compound. The oxygen concentration of the atmosphere is more preferably not more than 2% by volume, especially preferably not more than 1% by volume, and most preferably not more than 0.1% by volume. In order to reduce the oxygen concentration to more than the necessity, a large amount of an inert gas such as nitrogen is required, and therefore, such is not preferable from the viewpoint of production costs.

As a measure for regulating the oxygen concentration to not more than 6% by volume, it is preferred to substitute the air (nitrogen concentration: about 79% by volume, oxygen concentration: about 21% by volume) with other gas. It is especially preferred to substitute (purge) the air with nitrogen.

By feeding an inert gas into an ionizing radiation irradiation chamber and setting up a condition so as to slightly blow out the inert gas into a web inlet side of the irradiation chamber, not only it is possible to exclude entrained air following the web conveyance and to effectively decrease an oxygen concentration of a reaction chamber, but it is possible to effectively reduce a substantial oxygen concentration on the polar surface having large hardening hindrance due to oxygen. The direction of the inert gas flow on the web inlet side of the irradiation chamber can be controlled by regulating a balance between air supply and exhaustion of the irradiation chamber.

With respect to a method for excluding the entrained air, it is preferably employed to blow the inert gas directly on the web surface.

In hardening, it is preferable that the film surface is heated at 60° C. or higher and not higher than 170° C. When the heating temperature is lower than 60° C., an effect by heating is low, whereas when it exceeds 170° C., there is caused a problem such as deformation of the substrate. The heating temperature is more preferably from 60° C. to 100° C. The temperature of the “film surface” as referred to herein means a temperature of the film surface of a layer to be hardened. Furthermore, the time required for reaching the foregoing temperature is 0.1 seconds or more and not more than 300 seconds, and more preferably not more than 10 seconds after starting the UV irradiation. When the time for keeping the temperature of the film surface within the foregoing temperature range is too short, the reaction of the hardenable composition capable of forming a film cannot be accelerated. On the other hand, when it is too long, an optical performance of the film is lowered, and there is caused a problem in the production such that equipment becomes large.

Though the heating method is not particularly limited, preferred examples thereof include a method of heating a roll and bringing it into contact with the film; a method of blowing heated nitrogen; and irradiation with far infrared rays or infrared rays. A method of performing heating while making a medium such as warm water, vapors and oils flow into a rotating metal roll disclosed in Japanese Patent No. 2523574 can be utilized, too. As a measure for heating, a dielectric heating roll or the like may be used.

In the invention, it is possible to harden at least one layer as stacked on the support by irradiation with ionizing radiations plural times. In that case, it is preferable that the irradiation with ionizing radiations is carried out at least two times in continuous reaction chambers where the oxygen concentration does not exceed 3% by volume. By carrying out the irradiation with ionizing radiations plural times in reaction chambers having the same low oxygen concentration, it is possible to effectively ensure the reaction time necessary for hardening.

In particular, in the case of increasing the manufacturing speed for high productivity, in order to ensure energy of ionizing radiations necessary for the hardening reaction, it is necessary to carry out the irradiation with ionizing radiations plural times.

Also, in the case where a hardening rate [100—(residual functional group content)] is a value less than 100%, in providing a layer thereon and hardening by ionizing radiations and/or heat, when the hardening rate of a lower layer is higher than that before providing an upper layer, the adhesion between the lower layer and the upper layer is improved, and therefore, such is preferable.

### EXAMPLES

The invention is more specifically described with reference to the following Examples. The materials, use amounts, proportions, treatment contents, treatment procedures and so on described in the following Examples can be properly changed unless otherwise deviated from the gist of the invention. Accordingly, it should not be construed that the scope of the invention is limited to the following specific examples.

### [Preparation of Polyrotaxane and Crosslinked Polyrotaxane]

The preparation of each of a polyrotaxane and a crosslinked polyrotaxane was carried out while making the following preparation methods disclosed in Japanese Patents Nos. 2810264 and 3475252 by reference.

A preparation method of a compound in the case of using α-cyclodextrin as a cyclic molecule, polyethylene glycol as a linear molecule, a 2,4-dinitrophenyl group as a blocking group and cyanuric chloride as a crosslinking agent, respectively is described.

For a blocking treatment to be carried out later, the both end terminals of polyethylene glycol are modified with an amino group, thereby obtaining a polyethylene glycol derivative. α-Cyclodextrin and the polyethylene glycol derivative are mixed to prepare a polyrotaxane. In the preparation, when the maximum inclusion amount is defined to be 1, for example, a mixing time and a mixing temperature can be regulated to from 1 to 48 hours and from 0° C. to 100° C., respectively such that the inclusion amount is from 0.001 to 0.6 relative to 1.

In general, so far as polyethylene glycol having an average molecular weight of 20,000 is concerned, α-cyclodextrin can be included in the number of 230 at maximum. Accordingly, this value is the maximum inclusion amount. The foregoing condition is a condition under which α-cyclodextrin is included in the number of from 60 to 65 (63) in average, namely a value of from 0.26 to 0.29 (0.28) of the maximum inclusion amount by using polyethylene glycol having an average molecular weight of 20,000. The inclusion amount of α-cyclodextrin can be confirmed by means of NMR, light absorption, elemental analysis or the like.

The obtained polyrotaxane is allowed to react with 2,4-dinitrofluorobenzene dissolved in DMF, thereby obtaining a blocked polyrotaxane. Subsequently, the obtained blocked polyrotaxane is dissolved in a sodium hydroxide aqueous solution. To this solution, cyanuric chloride is added, and the mixture is allowed to react, thereby obtaining a crosslinked polyrotaxane in which α-cyclodextrins are crosslinked with each other.

### [Preparation of Unmodified Polyrotaxane (PR-1)]

### <Activation of the Both End Terminals of Polyethylene Glycol>

In a 100-mL Erlenmeyer flask, 4 g of polyethylene glycol (hereinafter abbreviated as “PEG”, average molecular weight: 20,000) and 20 mL of dry methylene chloride were charged, thereby dissolving PEG. This solution was placed under an argon atmosphere, and 0.8 g of 1,1′-carbonyldiimidazole was added thereto. Subsequently, the mixture was stirred and allowed to react under an argon atmosphere at room temperature (20° C.) for 6 hours.

The above-obtained reaction product was poured into 300 ml of diethyl ether stirred at a high speed. After allowing the mixture to stand for 10 minutes, a liquid having a precipitate was centrifuged at 10,000 rpm for 5 minutes. The precipitate was taken out and dried in vacuo at 40° C. for 3 hours.

The obtained product was dissolved in 20 mL of methylene chloride. This solution was added dropwise to 10 mL of ethylenediamine over 3 hours, and after completion of the dropwise addition, the mixture was stirred for 40 minutes. The obtained reaction product was applied to a rotary evaporator, thereby removing the methylene chloride. Thereafter, the residue was dissolved in 50 mL of water, and the solution was charged in a dialysis tube (fractional molecular weight: 8,000) and dialyzed in water for 3 days. The obtained dialyzate was dried by a rotary evaporator. This dry material was further dissolved in 20 mL of methylene chloride and reprecipitated from 180 mL of diethyl ether. A liquid having a precipitate was centrifuged at 100,000 rpm for 5 minutes and dried in vacuo at 40° C. for 2 hours, thereby obtaining 2.83 g of a product having an amino group introduced at the both end terminals of PEG.

### <Preparation of Polyrotaxane>

3.6 g of α-cyclodextrin (hereinafter abbreviated as “α-CD”) and 0.9 g of the above-prepared compound (molecular weight: about 20,000) were each dissolved in 15 mL of water at 80° C. and then mixed. The mixture was refrigerated at 5° C. for 6 hours, thereby preparing a polyrotaxane. Thereafter, the polyrotaxane was dried in vacuo at 40° C. for 12 hours.

### <Preparation of Blocked Polyrotaxane>

The above-obtained polyrotaxane was charged in a 100-mL Erlenmeyer flask. Separately, a mixed solution of 10 mL of N,N-dimethylformamide and 2.4 mL of 2,4-dinitrofluorobenzene was prepared; this mixed solution was added dropwise to the flask having the polyrotaxane charged therein; and the mixture was allowed to react at normal temperature under argon sealing. After 5 hours, 40 mL of dimethyl sulfoxide was added to the mixture to prepare a transparent solution. This solution was added dropwise to 750 mL of vigorously stirred water, thereby obtaining a pale yellow precipitate. This precipitate was again dissolved in 50 mL of dimethyl sulfoxide, and the solution was added dropwise to 700 mL of a vigorously stirred 0.1% sodium chloride aqueous solution, thereby again forming a precipitate. This precipitate was washed with water and methanol and thereafter, centrifuged thrice at 10,000 rpm for one minute in each time. The obtained material was dried in vacuo at 50° C. for 12 hours, thereby obtaining 3.03 g of a blocked polyrotaxane, namely an unmodified polyrotaxane (PR-1).

### [Preparation of Hydrophobilized Modified Polyrotaxane (PR-2)]

### <Preparation of End Terminal-Sealed Polyrotaxane>

4.5 g of polyethylene glycol bisamine having a number average molecular weight of 20,000 and 18.0 g of α-cyclodextrin were added to 150 mL of water and dissolved upon heating to 80° C. The solution was cooled and allowed to stand at 5° C. for 16 hours. A formed white precipitate in a paste form was aliquoted and dried.

The foregoing dry material was added to a mixed solution of 12.0 g of 2,4-dinitrofluorobenzene and 50 g of dimethylformamide, and the mixture was stirred at room temperature for 5 hours. 200 mL of dimethyl sulfoxide (DMSO) was added to the reaction mixture and dissolved. Thereafter, the solution was poured into 3,750 mL of water, thereby aliquoting a deposit. After again dissolving the deposit in 250 mL of DMSO, the solution was again poured into 3,500 mL of 0.1% salt water, thereby aliquoting a deposit. The deposit was washed thrice with water and methanol, respectively and then dried in vacuo at 50° C. for 12 hours. There was thus obtained 2.0 g of an inclusion compound in which polyethylene glycol bisamine was included in a pierced state in α-cyclodextrin, and a 2,4-dinitrophenyl group was bonded to an amino group at the both end terminals.

The obtained inclusion compound (end terminal-sealed blocked polyrotaxane) was subjected to ultraviolet ray absorption measurement and ¹H-NMR measurement, thereby calculating the inclusion amount of α-cyclodextrin. As a result, the inclusion amount was found to be 72.

The inclusion amount can be calculated by means of ultraviolet ray absorption measurement and ¹H-NMR measurement. Specifically, in the ultraviolet ray absorption measurement, the inclusion amount of the cyclodextrin was calculated by measuring a molar absorption coefficient of each of the synthesized inclusion compound and 2,4-dinitroaniline at 360 nm. Also, in the ¹H-NMR measurement, the inclusion amount was calculated from an integral ratio of a hydrogen atom of the polyethylene moiety and a hydrogen atom of the cyclodextrin moiety.

### <Acetyl Modification of End Terminal-Sealed Blocked Polyrotaxane>

1 g of the above-synthesized inclusion compound (end terminal-sealed blocked polyrotaxane) was dissolved in 50 g of a lithium chloride/N,N-dimethylacetamide 8% solution. 6.7 g of acetic anhydride, 5.2 g of pyridine and 100 mg of N,N-dimethylaminopyridine were added thereto, and the mixture was stirred at room temperature overnight. The reaction solution was flown into methanol, and a deposited solid was separated by means of centrifugation. The separated solid was dried and then dissolved in acetone. The solution was flown into water, and a deposited solid was separated by means of centrifugation and then dried, thereby obtaining 1.2 g of an acetyl-modified, hydrophobilized modified polyrotaxane (PR-2).

The obtained acetyl-modified polyrotaxane was subjected to ¹H-NMR measurement, thereby calculating the acetyl introduction amount. As a result, the acetyl introduction amount was found to be 75%.

### [Preparation of Crosslinked Polyrotaxane Compound (PR-3)]

A solution of 0.18 g of cyanuric chloride dissolved in 20 g of acetone was gradually added dropwise to 80 g of vigorously stirred ice water. There was thus obtained a dispersion (liquid A) of cyanuric chloride. Separately, a solution (liquid B) of 2.4 g of α-cyclodextrin and 0.53 g of sodium carbonate dissolved in 200 g of water was prepared.

The foregoing liquid A was added dropwise to the gently stirred liquid B.

Thereafter, the liquid temperature was raised to 50° C., and stirring was continued for 6 hours. Thereafter, the liquid temperature was decreased to 25° C., thereby obtaining a solution (liquid C). The liquid C was mixed with a solution of 10 g of polyethylene glycol (average molecular weight: 20,000) dissolved in 700 g of water, and gentle stirring was continued at 25° C. for 24 hours. Furthermore, this liquid was concentrated using an evaporator until the whole reached 500 g, thereby obtaining a solution (liquid D). A solution (liquid E) of 0.46 g of 1-aminododecane dissolved in 500 g of tetrahydrofuran was mixed with the foregoing liquid D, and stirring was continued at 80° C. for 6 hours. Furthermore, 0.21 g of sodium carbonate was dissolved in this liquid, thereby obtaining a solution (liquid F).

A solution of 0.21 g of methacrylic acid chloride dissolved in 20 g of tetrahydrofuran was added to the triethylamine-containing liquid F, and the mixture was allowed to react at 50° C. for 6 hours while stirring. The formed hydrochloride of triethylamine was removed by filtration, thereby obtaining a solution (liquid G). The solvent of this liquid G was removed using an evaporator, thereby obtaining a crosslinked polyrotaxane compound (PR-3).

### [Preparation of Polyrotaxane (PR-4) Having an Unsaturated Double Bond]

### <Introduction of Polymerizable Group>

1 g of the above-synthesized acetyl-modified polyrotaxane (PR-2) was dissolved in 50 g of a lithium chloride/N,N-dimethylacetamide 8% solution. 5.9 g of acrylic acid chloride, 5.2 g of pyridine and 100 mg of N,N-dimethylaminopyridine were added thereto, and the mixture was stirred at room temperature two nights. The reaction solution was flown into methanol, and a deposited solid was separated by means of centrifugation. The separated solid was dried and then dissolved in acetone. The solution was flown into water, and a deposited solid was separated by means of centrifugation and then dried, thereby obtaining 0.8 g of an acryloyl- and acetyl-modified polyrotaxane (PR-4).

The obtained acryloyl- and acetyl-modified polyrotaxane (PR-4) was subjected to ¹H-NMR measurement, thereby calculating the acryloyl and acetyl introduction amount. As a result, the introduction amount was found to be 87%. That is, the acryloyl introduction amount is 12%.

### (Preparation of Hollow Silica Dispersion A)

To 500 g of a hollow silica fine particle sol (a silica sol in isopropyl alcohol, average particle size: 60 nm, shell thickness: 10 nm, silica concentration: 20% by mass, refractive index of silica particles: 1.31; as prepared by changing the size in conformity to Preparation Example 4 of JP-A-2002-79616), 5 g of acryloyloxypropyltrimethoxysilane (manufactured by Shin-Etsu Chemical Co., Ltd.) and 1.5 g of diisopropoxyaluminum ethyl acetate were added and mixed, to which was then added 3g of ion exchanged water. After allowing the mixture to react at 60° C. for 8 hours, the reaction mixture was cooled to room temperature. The generation of a foreign matter was not observed in the dispersion, and the solids concentration was regulated with isopropyl alcohol, thereby obtaining a 20% by mass hollow silica dispersion A. The viscosity was 5 mPa·s at 25° C.

### (Preparation of Coating Solution (HCL-1) for Hard Coat Layer)

A coating solution having the following composition was filtered through a polypropylene-made filter having a pore diameter of 30 μm, thereby preparing a coating solution (HCL-1) for hard coat layer.

Composition of coating solution (HCL-1) for hard coat layer

| | |
|---|---|
| DPHA: | 10.0 g |
| PET-30: | 36.0 g |
| BISCOAT 360: | 10.0 g |
| IRGACURE 127: | 2.0 g |
| SP-13: | 0.04 g |
| Methyl isobutyl ketone: | 13.0 g |
| Methyl ethyl ketone: | 6.0 g |

Each of the used compounds is as follows.
DPHA: Mixture of dipentaerythritol pentaacrylate and dipentaerythritol hexaacrylate (manufactured by Nippon Kayaku Co., Ltd.)
PET-30: Mixture of pentaerythritol triacrylate and pentaerythritol tetraacrylate (manufactured by Nippon Kayaku Co., Ltd.)
BISCOAT 360: Ethylene oxide-modified trimethylolpropane triacrylate (manufactured by Osaka Organic Chemical Industry Ltd.)
IRGACURE 127: Photopolymerization initiator (manufactured by Ciba Specialty Chemicals)
SP-13: Fluorine based leveling agent

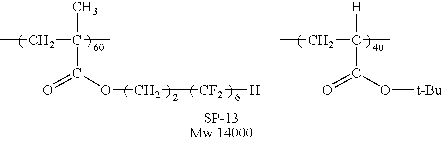

### [Application of Hard Coat Layer]

By using a slot die coater disclosed in FIG. 1 of JP-A-2003-211052, an 80 μm-thick triacetyl cellulose film “TAC-TD80U” (manufactured by FUJIFILM Corporation) (refractive index: 1.48) was wound out in a rolled state; the coating solution (HCL-1) for hard coat layer was coated in a dry thickness of 12 μm thereon; after drying at 30° C. for 15 seconds and 90° C. for 40 seconds, the coating layer was hardened in an atmosphere having an oxygen concentration of not more than 100 ppm upon irradiation with ultraviolet rays at an irradiation dose of 70 mJ/cm² by using an “air-cooled metal halide lamp” (manufactured by Eyegraphics Co., Ltd.) of 160 W/cm under purging with nitrogen, thereby preparing a hard coat layer (HC-101), followed by winding up.

### (Preparation of Coating Solution (Ln-1) for Low Refractive Index Layer)

3.30 g of a mixture of dipentaerythritol pentaacrylate and dipentaerythritol hexaacrylate (DPHA, manufactured by Nippon Kayaku Co., Ltd.), 5.60 g (in terms of solids content) of hollow silica fine particles (the hollow silica dispersion A having a solids concentration of 20% was used), 0.70 g of the polyrotaxane compound (PR-4), 0.20 g of reactive silicone X-22-164C (a trade name of Shin-Etsu Chemical Co., Ltd.), 0.20 g of a photopolymerization initiator (IRGACURE 127 (a trade name), manufactured by Ciba Specialty Chemicals), 80.0 g of methyl ethyl ketone, 26.8 g of isopropyl alcohol and 3.0 g of cyclohexanone were mixed to prepare a liquid having a solids content of 7% by mass. The liquid was filtered through a polypropylene-made filter having a pore size of 1 μm, thereby preparing a coating solution (Ln-1) for low refractive index layer.

### (Preparation of Coating Solutions (Ln-2 to Ln-10) for Low Refractive Index Layer)

Coating solutions for low refractive index layer were prepared in the same manner as in the preparation of the coating solution (Ln-1) for low refractive index layer, except for changing the respective components other than the solvent as shown in the following table and regulating the solids concentration to 7%.

TABLE 1

| | | Ln-1 | Ln-2 | Ln-3 | Ln-4 | Ln-5 | Ln-6 | Ln-7 | Ln-8 | Ln-9 | Ln-10 | Ln-11 | Ln-12 |
|---|---|---|---|---|---|---|---|---|---|---|---|---|---|
| Component (A) | DPHA | 3.30 | 4.00 | 2.60 | 2.60 | 2.60 | 2.60 | 3.10 | 3.00 | 2.40 | 2.30 | 2.30 | 2.70 |
| | BISCOAT 360 | — | — | — | — | — | — | — | — | — | 0.30 | — | — |
| Component (B) | Hollow silica fine | 5.60 | 5.60 | 6.50 | 6.50 | 6.50 | 6.50 | 6.50 | 6.50 | 6.50 | 6.50 | 7.00 | 7.00 |
| | particles | | | | | | | | | | | | |
| Component (C) | PR-1 | — | — | — | 0.50 | — | — | — | — | — | — | — | — |
| | PR-2 | — | — | — | — | 0.50 | — | — | — | — | — | — | — |
| | PR-3 | — | — | — | — | — | 0.50 | — | — | — | — | — | — |
| | PR-4 | 0.70 | — | 0.50 | — | — | — | — | 0.10 | 0.70 | 0.50 | 0.40 | — |
| Polymerization | IRGACURE | 0.20 | 0.20 | 0.20 | 0.20 | 0.20 | 0.20 | 0.20 | 0.20 | 0.20 | 0.20 | 0.10 | 0.10 |
| initiator | 127 | | | | | | | | | | | | |
| Antifouling agent | X-22-164C | 0.20 | 0.20 | 0.20 | 0.20 | 0.20 | 0.20 | 0.20 | 0.20 | 0.20 | 0.20 | 0.20 | 0.20 |

| | | | | | | | | | | | | |
|---|---|---|---|---|---|---|---|---|---|---|---|---|
| Component (C)/[(Component | 18 | 0 | 16 | 16 | 16 | 16 | 0 | 3 | 23 | 18 | 15 | 0 |
| (A) + Component (C)] (%) | | | | | | | | | | | | |

Each of the coating solutions (Ln-1 to Ln-10) for low refractive index layer was coated on the hard coat layer (HC-101) using a die coater such that the thickness of the low refractive index layer was 95 nm; and after drying at 30° C. for 15 seconds and 80° C. for 120 seconds, the coating layer was irradiated in an atmosphere having an oxygen concentration of not more than 100 ppm with ultraviolet rays at an irradiation dose of 500 mJ/cm² by using an “air-cooled metal halide lamp” (manufactured by Eyegraphics Co., Ltd.) of 240 W/cm under purging with nitrogen. There were thus prepared optical film samples 101 to 110.

### (Evaluation of Optical Film)

The foregoing optical films were evaluated as follows.

### (1) Average Reflectance:

The surface of the antireflective hard coat film on which the hard coat layer was not stacked was roughed by sand paper and then subjected to a light absorption treatment (a transmittance at from 380 to 780 nm being less than 10%) with a black ink, followed by measurement on a black table under the following condition.

By using a spectrophotometer “V-550” (manufactured by JASCO Corporation) having an adaptor “ARV-474” installed therein, a mirror reflectance at each of an incident angle of 5° and an outgoing angle of −5° was measured in a wavelength region of from 380 to 780 nm. For the result, an average reflectance at from 450 to 650 nm was used.

### (2) Coating Surface Properties:

The optical film was cut out into a sheet having a size of 12 cm in square; a black adhesive-provided PET film was stuck on the back side; and the resulting optical film was visually evaluated using a three band fluorescent lamp at 500 luxes and 1,000 luxes, respectively according to the following criteria. The evaluation at 1,000 luxes is able to detect even slight unevenness. Five sheets having a size of 12 cm in square were observed, thereby evaluating the frequency of unevenness.

A: Even in the observation at 1,000 luxes, unevenness is not found.

B: In the observation at 1,000 luxes, unevenness in the number of not more than one is found, but in the observation at 500 luxes, unevenness is not found.

C: In the observation at 500 luxes, unevenness in the number of less than one is found.

D: In the observation at 500 luxes, unevenness in the number of from 1 to 3 is found.

E: In the observation at 500 luxes, unevenness in the number of more than 3 is found.

### (3) Pencil Hardness Evaluation:

The pencil hardness evaluation described in JIS K5400 was carried out as an index of the scratch resistance. The antireflective hard coat film was subjected to humidity control at a temperature of 25° C., a humidity of 60% RH and for 2 hours. Thereafter, a scratch test was repeated five times under a load of 4.9 N using a pencil for test having a hardness of from HB to 5H as defined in JIS S6006; the resulting film was allowed to stand for 24 hours under a condition at a temperature of 25° C. and a humidity of 60% RH and then evaluated according to the following criteria; and the highest hardness at which the film was evaluated as “OK” was defined as an evaluation value.

OK: In the evaluation at N=5, the number of scratches is not more than 2.

NG: In the evaluation at N=5, the number of scratches is 3 or more.

The evaluation results are shown in the following table.

TABLE 2

| | Coating | | | | |
|---|---|---|---|---|---|
| | solution | | | | |
| | for low | | | | |
| | refractive | | Coating | | |
| Sample | index | Reflectance | surface | Pencil | |
| No. | layer | (%) | properties | hardness | Remark |
| 101 | Ln-1 | 1.69 | A | 4H | Invention |
| 102 | Ln-2 | 1.72 | D | 2H | Comparison |
| 103 | Ln-3 | 1.43 | A | 4H | Invention |
| 104 | Ln-4 | 1.43 | B | 3H | Invention |
| 105 | Ln-5 | 1.43 | A | 4H | Invention |
| 106 | Ln-6 | 1.43 | A | 4H | Invention |
| 107 | Ln-7 | 1.50 | E | H | Comparison |
| 108 | Ln-8 | 1.45 | B | 4H | Invention |
| 109 | Ln-9 | 1.45 | A | 3H | Invention |
| 110 | Ln-10 | 1.43 | A | 4H | Invention |
| 111 | Ln-11 | 1.26 | B | 3H | Invention |
| 112 | Ln-12 | 1.43 | E | HB | Comparison |

According to the foregoing table, when it is intended to realize a low refractive index by incorporating the low refractive index inorganic fine particles into the low refractive index layer and increasing its content, in the case of not incorporating the polyrotaxane compound, the coating surface properties are deteriorated, the refractive index increases, or the pencil hardness is low. It is noted that by incorporating the polyrotaxane which is the component (C) of the invention, an optical film with improved coating surface properties, low reflectance and a high pencil hardness is obtained.

### <Preparation of Polarizing Plate and Liquid Crystal Display Device>

A triacetyl cellulose film having a thickness of 80 μm (TAC-TD80U, manufactured by FUJIFILM Corporation) which had been dipped in a 1.5 moles/L NaOH aqueous solution at 55° C. for 2 minutes, neutralized and then washed with water was adhered on one surface of a polarizer prepared by adsorbing iodine onto polyvinyl alcohol and stretching, and each of the optical films of the foregoing sample Nos. 101 to 112 was stacked on the other surface of the polarizer, thereby preparing a polarizing plate.

A liquid crystal display device in which a low refractive index layer was disposed on the uppermost layer was prepared using this polarizing plate. As a result, a liquid crystal display device in which the surface is uniform, the reflectance is low, the reflection of external light is small, a reflected image is not noticeable, and excellent visibility is revealed was obtained.

According to the invention, an optical film having a low refractive index layer which is excellent in at least one of low reflection, coating surface properties, strength of a coating film and mass productivity and which is obtained by hardening a composition containing (A) a fluorine atom-free polymerizable compound having two or more ethylenically unsaturated groups in one molecule thereof; (B) low refractive index inorganic fine particles; and (C) a polyrotaxane compound can be provided.

The entire disclosure of each and every foreign patent application from which the benefit of foreign priority has been claimed in the present application is incorporated herein by reference, as if fully set forth.

What is claimed is:

1. An optical film, comprising:
a transparent support; and
at least one low refractive index layer on or above the transparent support, the low refractive index layer being obtained by hardening a composition containing:
(A) a fluorine atom-free polymerizable compound having two or more ethylenically unsaturated groups in one molecule thereof;
(B) low refractive index inorganic fine particles; and
(C) a polyrotaxane compound.

2. The optical film according to claim 1,
wherein the fluorine atom-free polymerizable compound (A) contains an ethylene oxide-modified compound.

3. The optical film according to claim 1,
wherein the low refractive index inorganic fine particles (B) are inorganic fine particles containing porous or hollow silica as a major component.

4. The optical film according to claim 1,
wherein the polyrotaxane compound (C) has an ethylenically unsaturated group.

5. The optical film according to claim 1,
wherein the composition further contains (D) a polymerization initiator.

6. The optical film according to claim 1, further comprising:
at least one optical functional layer between the transparent support and the low refractive index layer.

7. A polarizing plate, comprising:
a polarizer; and
at least two protective films sandwiching the polarizer,
wherein the optical film according to claim 1 is used for at least one of the at least two protective films.

8. An image display device, comprising:
the optical film according to claim 1 on the uppermost surface of a display.

9. A method for manufacturing an optical film including a transparent support and at least one low refractive index layer on or above the transparent support, the method comprising:
applying a composition containing:
(A) a fluorine atom-free polymerizable compound having two or more ethylenically unsaturated groups in one molecule thereof;
(B) low refractive index inorganic fine particles;
(C) a polyrotaxane compound; and
(E) at least two kinds of volatile solvents, on a transparent support, so as to form an applied composition; and
hardening the applied composition to form the low refractive index layer.

10. The method according to claim 9,
wherein the composition further contains (D) a polymerization initiator.

11. The method according to claim 9,
wherein the fluorine atom-free polymerizable compound (A) contains an ethylene oxide-modified compound.

12. The method according to claim 9,
wherein the low refractive index inorganic fine particles (B) are inorganic fine particles containing porous or hollow silica as a major component.

13. The method according to claim 9,
wherein the polyrotaxane compound (C) has an ethylenically unsaturated group.

14. The method according to claim 9,
wherein at least two kinds of volatile solvents (E) are a combination of at least two kinds selected from the group consisting of alcohols and derivatives thereof, ethers, ketones, hydrocarbons and esters.

15. The optical film according to claim 1,
wherein a mass ratio of [component (C)/(component (A)+component (C))] in the low refractive index layer is from 3 to 25%.

16. The method according to claim 9,
wherein a mass ratio of [component (C)/(component (A)+component (C))] in the low refractive index layer is from 3 to 25%.
